(19) United States
(12) Patent Application Publication
(10) Pub. No.: US 2012/0095779 A1
(43) Pub. Date: Apr. 19, 2012

(54) METHOD AND APPARATUS FOR PROVIDING LOCATION-BASED DATA AND SERVICES IN HEALTHCARE ENVIRONMENTS

(76) Inventors: Michael S. Wengrovitz, Concord, MA (US); Robert Hemmerich, Ottawa (CA)

(21) Appl. No.: 12/903,261

(22) Filed: Oct. 13, 2010

(51) Int. Cl. G06Q 50/00

(52) U.S. Cl. 705/3

(57) ABSTRACT

A capability for providing location-based data and/or services is provided herein. The location-based data and/or services may be provided within any suitable environment, such as, for example, a healthcare environment. With the context of a healthcare environment, a healthcare professional carries a user device within the healthcare environment, and the location of the user device within the healthcare environment is tracked such that, when the user device is determined to be associated with a location of a patient, the user device automatically receives patient data associated with the patient, for use by the healthcare professional in providing or supporting care for the patient. The patient data may include patient information associated with the patient (e.g., medical history, previous and recent test results, and the like) and/or information for use in providing services to the healthcare professional(e.g., push-to-talk services, location-based message delivery services, location-based presence services, and the like).

### FIELD OF THE INVENTION

The invention relates generally to delivery of data and services and, more specifically but not exclusively, to location-based delivery of data and services.

### BACKGROUND

Doctors, nurses, and other medical professionals routinely visit patients in hospital rooms to monitor patient status and progress. It is important for such medical personnel to have patient data and the most current and relevant medical information and test results upon entry to the room, and to be able to quickly and simply use communication services in conjunction with such patient visits. For example, when a doctor enters a patient's room, having access to recent MRI images and being able to speak to another medical expert about interpretation of these images improves overall patient care and simplifies the doctor's job.

In the existing scenarios, doctors often do not have the latest information when visiting the patient's room, and establishing voice communication with other experts is awkward, complex, and inefficient. For example, in the existing scenarios, doctors typically carry around paper folders containing medical test results that are at least several hours old, and must manually lookup and then dial the telephone number of another medical expert—only to find out that the other expert then does not answer the call. The situation is even more complex when the doctor wants to consult with whichever specialist is currently on call, or to have a voice conference call with multiple specialists simultaneously.

### SUMMARY

Various embodiments for providing location-based data and services within various environments are depicted and described herein.

In one embodiment, a method includes determining a location of a user device, determining a person associated with the determined location of the user device, and initiating a process for propagating person data associated with the person toward the user device.

In one embodiment, an apparatus includes a processor configured for propagating, from a user device toward a network element, information adapted for use by the network element in determining a location of the user device, and receiving, at the user device, person data associated with a person determined to be associated with the location of the user device.

### BRIEF DESCRIPTION OF THE DRAWINGS

The various embodiments discussed herein can be readily understood by considering the following detailed description in conjunction with the accompanying drawings, in which:

FIG. 1 depicts a high-level block diagram of an exemplary environment for providing location-based data and services using tablets and a Location-Based Service System (LBSS);

FIG. 2 depicts a high-level block diagram illustrating one embodiment of a tablet of FIG. 1;

FIG. 3 depicts a high-level block diagram illustrating one embodiment of the LBSS of FIG. 1;

FIG. 4 depicts an exemplary use of a tablet of FIG. 1 for accessing and utilizing location-based data and services;

FIG. 5 depicts one embodiment of a method for delivery of location-based data and services to a tablet of FIG. 1;

FIG. 6 depicts an exemplary environment for determining the indoor location of a tablet of FIG. 1 where the tablet includes a Bluetooth detector and the rooms of the hospital of FIG. 1 include Bluetooth radiators;

FIG. 7 depicts one embodiment of a method for determining the indoor location of a tablet of FIG. 1; and

FIG. 8 depicts a high-level block diagram of a computer suitable for use in performing functions described herein.

To facilitate understanding, identical reference numerals have been used, where possible, to designate identical elements that are common to the figures.

### DETAILED DESCRIPTION OF THE INVENTION

A capability is provided for supporting delivery of location-based data and services. The location-based data and services may be delivered within any suitable environment, which may include indoor environments (e.g., delivery of location-based data and services based on indoor locations) and/or outdoor environments (e.g., delivery of location-based data and services in wider area locations).

Although the capability supporting delivery of location-based data and services is primarily depicted and described herein within the context of a healthcare environment in which delivery of location-based data and services to healthcare professionals is provided based on locations of patients within the healthcare environment, the capability supporting delivery of location-based data and services may be utilized within various other environments in which location-based data and/or services may be necessary and/or desirable.

A location-based healthcare capability is provided for enabling delivery of location-based data and services within a healthcare environment, such as a hospital, doctor's office, and the like.

The location-based healthcare capability provides timely delivery of location-based data and/or services in a healthcare environment, e.g., when healthcare professionals (e.g., doctors, nurses, other medical personnel, and the like) enter patient rooms in hospitals, doctor's offices, and similar healthcare locations. The location-based data may include patient data, which may include patient information and/or information configured for use in providing at least one location-based service associated with the patient. The patient information may include one or more of personal information of the patient, medical history of the patient, test results for the patient, and the like, as well as various combinations thereof. The information configured for use in providing at least one location-based service associated with the patient may be information configured for use in providing services such as patient information delivery services, voice communications services, voice conferencing services, call routing services, message forwarding services, presence reporting and tracking services, transcription services, and the like, as well as various combinations thereof. The location-based healthcare capability exploits the various benefits of tablet devices (e.g., portability, high-resolution touch screens, high-speed network access, and the like) while providing functionality for establishing and exploiting accurate indoor location information in order to efficiently deliver patient-related data (e.g., personal data, medical information, test results, and the like) and/or services (e.g., voice communications, messaging services, presence services, and the like).

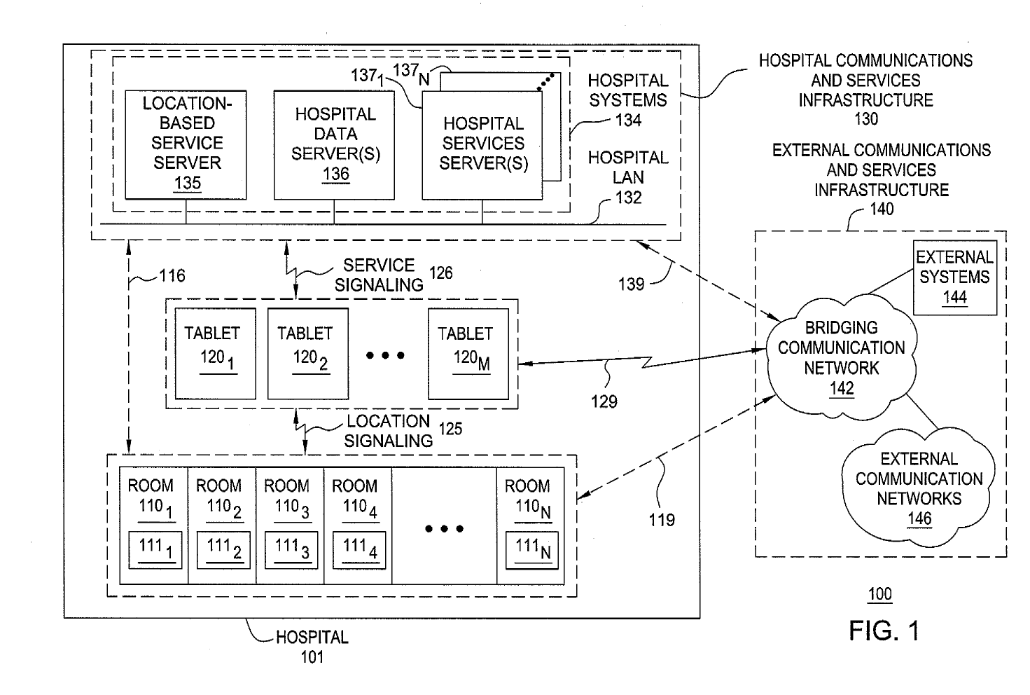

FIG. 1 depicts a high-level block diagram of an exemplary environment for providing location-based data and services.

As depicted in FIG. 1, exemplary environment 100 includes a hospital 101. The hospital 101 includes a plurality of patient rooms 110₁-110_{N} (collectively, patient rooms 110), a plurality of tablets 120₁-120ₘ (collectively, tablets 120), and hospital communications and services infrastructure 130, which cooperate to provide various aspects of the location-based healthcare capability depicted and described herein.

The hospital 101 may include any suitable numbers and arrangements of patient rooms 110 (e.g., disposed over any suitable numbers of floors, in any suitable arrangements on those floors, using rooms of any suitable size, and the like). The hospital 101 includes various other types of rooms (omitted for purposes of clarity) which may or may not be configured in a manner for utilizing the location-based healthcare capability (e.g., operating rooms, doctor's offices, clinics, and the like). The typical arrangement of a hospital, including patient rooms of the hospital, will be understood.

The patient rooms 110 each are arranged for supporting one or more patients, and may include various types of furniture, medical equipment, and the like for supporting patients and patient care. The patient rooms 110 may include any rooms in which patients may receive care, such as rooms in which patients typically reside while in the hospital 101, as well as other types of rooms in which patients may receive care while in hospital 101 (e.g., operating rooms, emergency rooms, and the like).

The patient rooms 110₁-110_{N} include a plurality of locator devices 111₁-111_{N} (collectively, locator devices 111), respectively.

In one embodiment, the locator devices 111 are radiator devices configured for being detected by associated detector devices (e.g., where the tablets 120 carried by the healthcare professionals are configured for detecting the radiator devices deployed within the patient rooms 110).

In one embodiment, the locator devices 111 are detector devices configured for detecting radiating devices (e.g., where the tablets carried by the healthcare professionals include radiator devices configured for being detected by the detector devices deployed within the patient rooms 110).

In such embodiments, the detector devices and radiator devices cooperate to enable indoor location determination (e.g., for detecting when specific healthcare professionals enter specific rooms within hospital 101).

In such embodiments, any suitable wireless communications capabilities may be utilized for the indoor location determination functions. For example, the radiators and detectors may utilize Bluetooth (BT), Wireless Fidelity (WiFi), and/or any other suitable wireless technologies.

In one embodiment, connectivity 116 is supported between patient rooms 110 and the hospital communications and services infrastructure 130 for enabling indoor location determination where indoor location determination is performed centrally by one or more devices of hospital communications and services infrastructure 130.

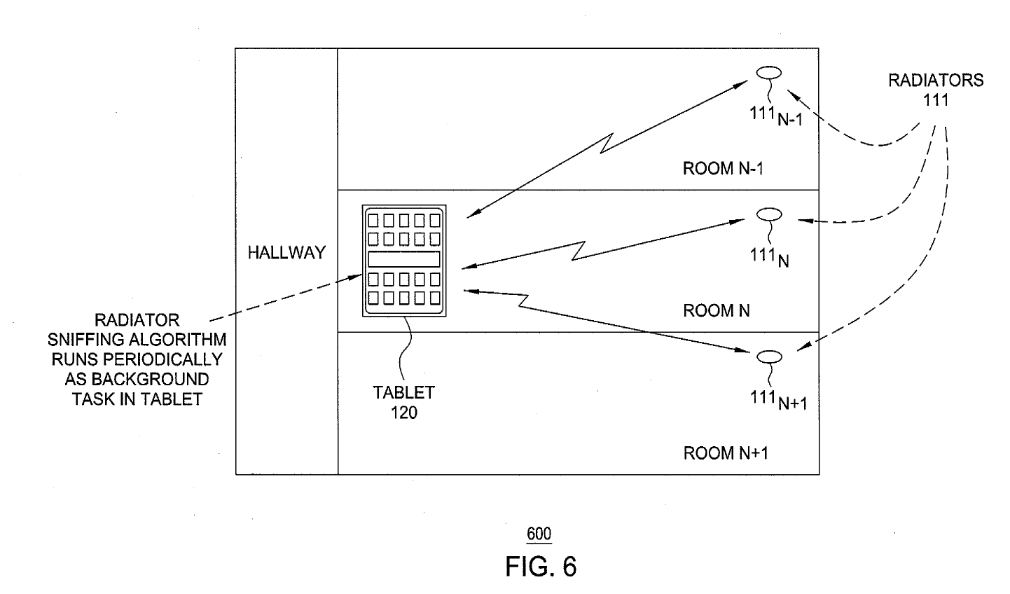

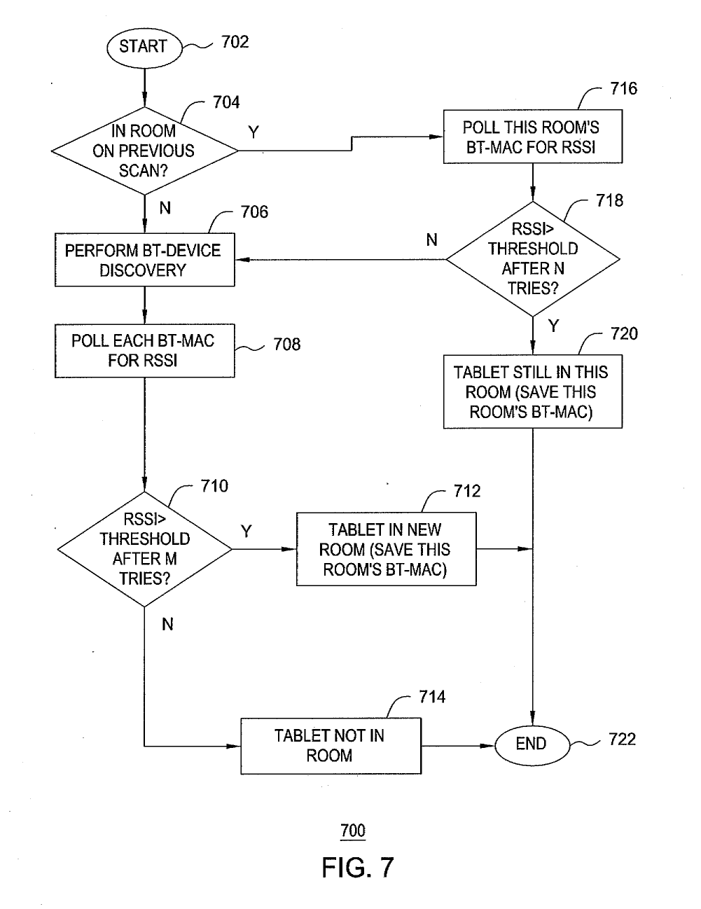

The operation of locator devices 111 in supporting indoor location determination functions may be better understood by way of reference to FIGS. 6 and 7.

The hospital 101 has doctors, nurses, and various other types of healthcare professionals who care for patients and/or support care of patients located in patient rooms 110. The healthcare professionals of hospital 101 carry tablet devices configured for providing the location-based healthcare capability that is depicted and described herein. The use of tablet devices by healthcare professionals is represented by tablets 120 depicted in FIG. 1.

The tablets 120 each are configured for providing various aspects of the location-based healthcare capability.

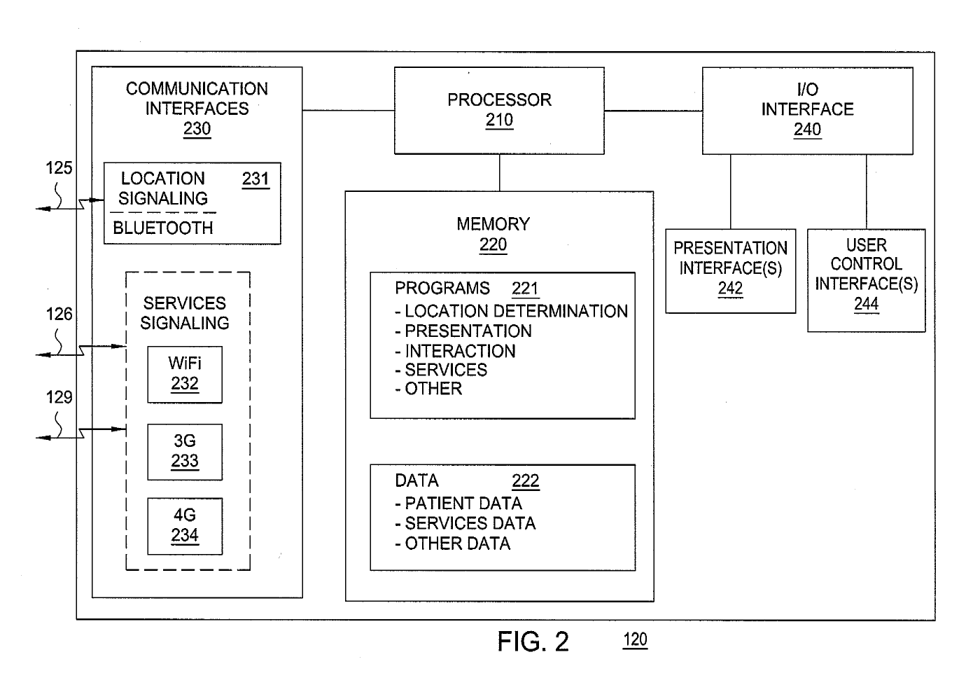

The tablets 120 may be implemented using any suitable tablet devices, such as Apple iPads, as well as any other tablet devices or other devices suitable for providing the location-based healthcare capability. The typical design and operation of tablet devices will be understood by one skilled in the art. Furthermore, adapting of tablet and/or other devices to provide tablets 120 which support the location-based healthcare capability will be understood by way of reference to the various teachings herein. An exemplary tablet 120 is depicted and described with respect to FIG. 2.

In one embodiment, tablets 120 are lightweight battery-powered devices, having interactive touch screens with high-speed network connectivity, which can be conveniently carried around by healthcare professionals in hospital 101. The tablets 120 are configured to enable the healthcare professionals to view patient information (e.g., medical records, test results, and the like) in high resolution. The tablets 120 are configured to enable the healthcare professionals to more easily communicate with other parties involved in or associated with care of patients, e.g., via addition of telephone capabilities to existing tablet devices (e.g., voice over IP), via addition of various advanced voice communications capabilities to existing tablet devices (e.g., click-to-call, click-to-conference, push-to-talk, and the like), and the like, as well as various combinations thereof. The tablets 120 are configured to perform various other functions for improving overall patient care.

The tablets 120 communicate with locator devices 111 of patient rooms 110 for enabling indoor location determination in which the indoor locations of the tablets 120 are tracked for use in providing delivery of location-based data and/or services to healthcare professionals carrying tablets 120. The use of location devices 111 deployed within patient rooms 110 enables indoor location determination to be performed on a per-room basis, such that, when the healthcare professionals carrying the tablets 120 are located within the patient rooms 110, the healthcare professionals may be automatically provided with location-based data and/or services associated with the patients of the patient rooms 110, respectively. As depicted in FIG. 1, tablets 120 communicate with locator devices 111 via location signaling 125, which may utilize any wireless communications capabilities suitable for enabling indoor location determination (e.g., Bluetooth, WiFi, or any other wireless technology suitable for this purpose). It will be appreciated that, while existing tablet devices, upon which tablets 120 may be based, typically have Bluetooth radios, these Bluetooth radios are typically only used for pairing with headsets and for file transfer; however, here, the Bluetooth radios may be used to enable accurate indoor location determination, which may be used for providing improved communication services within healthcare environments (e.g., via delivery of location-based data and services).

The tablets 120 communicate with hospital communications and services infrastructure 130 for receiving location-based data and providing the location-based data to healthcare professionals carrying tablets 120 and/or for using location-based services supported for healthcare professionals carrying tablets 120. As depicted in FIG. 1, the tablets 120 communicate with hospital communications and services infrastructure 130 via service signaling 126, which may utilize any wireless communications capabilities suitable for enabling delivery of data and services to tablets 120. For example, service signaling 126 may be provided using one or more of WiFi communications, cellular communications (e.g., 3G, 4G, and the like), and the like, as well as various combinations thereof).

The hospital 101 includes hospital communications and services infrastructure 130. The hospital communications and services infrastructure 130 includes a hospital local area network (LAN) 132 supporting communications within hospital 101 and a plurality of hospital systems 134 providing various data and services within hospital 101. The hospital systems 134 each are in communication with hospital LAN 132, thereby enabling access to such hospital systems 134 via hospital LAN 132.

The hospital LAN 132 may be any suitable type of local area network, which may utilize any suitable communications technologies. For example, hospital LAN 132 may support wired and wireless communications within the hospital 101 using any suitable wired and wireless communications technologies. For example, with respect to wired communications, hospital LAN 132 may support IP-based communications, Ethernet-based communications, and the like, as well as various combinations thereof. For example, with respect to wireless communications, hospital LAN 132 may support WiFi communications, cellular communications (e.g., 3G, 4G, and the like), and the like, as well as various combinations thereof.

The hospital systems 134 are configured for cooperating to provide various portions of the location-based healthcare capability depicted and described herein. The hospital systems 134 include a location-based service system (LBSS) 135, one or more hospital data servers (HDSs) 136 (referred to herein as HDS 136), and a plurality of hospital services servers (HSSs) 137₁-137_{N} (collectively, HSSs 137).

The LBSS 135 is configured for providing various aspects of the location-based healthcare capability. The LBSS 135 implements rule-based applications and scripts for supporting various functions of the location-based healthcare capability depicted and described herein, including various use cases. It will be appreciated that LBSS 135 is fully extensible so that additional services can be provided by changing the various applications and scripts hosted by LBSS 135.

The HDS 136 is configured for storing patient data for patients of hospital 101, and receiving and responding to requests for patient data for patients of hospital 101.

The requests/responses for patient data may be from/to any suitable devices. For example, requests may be received from LBSS 135 for patient data to be provided to LBSS 135, which may then provide the patient data to one or more tablets 120. For example, requests may be received from LBSS 135 for patient data to be provided directly to tablets 120 (e.g., where LBSS 135 determines a patient associated with a location of a tablet 120 and then instructs HDS 136 to provide the patient data for that patient to the tablet 120). For example, requests for patient data may be received directly from tablets 120 (e.g., where a person carrying a tablet 120 and/or a program on a tablet 120 initiates a request for additional patient data to be provided from HDS 136 to the tablet 120). It will be appreciated that patient data requests and/or responses may be routed to and/or from HDS 136 in any other manner suitable for providing the various functions of the location-based healthcare capability.

The patient data may include any suitable information, such as patient information associated with the patient, information configured for use in providing at least one location-based service associated with the patient, and the like, as well as various combinations thereof.

In one embodiment, for example, the patient information for a patient may include one or more of personal information associated with the patient (e.g., name, address, gender, date of birth, and the like), patient emergency contact information for the patient (e.g., names, phone numbers, and like data associated with members of the patient's family, friends of the patient, and the like, as well as various combinations thereof), patient medical history (e.g., medical history of the patient, medical history of members of the patient's family, and the like), medical information collected for the patient while in the hospital 101 (e.g., results of heart rate monitors, blood pressure, blood tests, and the like, as well as various combinations thereof), lab results for tests performed on the patient at hospital 101 and/or outside of hospital 101 (e.g., x-rays, EKG results, and the like), and the like, as well as various combinations thereof.

In one embodiment, for example, the information configured for use in providing at least one location-based service associated with the patient may include information for use in providing services such as patient information delivery services, voice communications services, voice conferencing services, call routing services, message forwarding services, presence reporting and tracking services, transcription services, and the like, as well as various combinations thereof. For example, such information may include telephone numbers of personal contacts of the patient for use in setting up voice communications associated with voice communication services, telephone numbers of other healthcare professionals involved with the care of the patient for use in setting up voice communications associated with voice communications services, presence information associated with other healthcare professionals which may be involved with the care of the patient for use in locating other healthcare professionals in conjunction with presence services, and the like, as well as various combinations thereof). In this sense, while at least some such information may not typically be considered to be directly associated with the patient, such information may be considered to be associated with the patient within the context of providing the location-based healthcare capability, e.g., where the information supports services which may be used for providing and/or supporting care of the patient (e.g., patient information delivery services, voice communications services, conferencing services, call routing services, message forwarding services, presence reporting and tracking services, transcription services, and the like, as well as various combinations thereof), services which enable the healthcare professional to better conduct his or her duties while also providing and/or supporting care of the patient, and the like. The location-based services may be provided using location-based data and/or any other data suitable for providing location-based services, which may depend on the type(s) of location-based services being provided.

It will be appreciated that the patient data may include any data, associated with the patient, which may be of interest to any healthcare professional(s) involved in providing and/or supporting the care of the patient and/or which may be used for providing services to any healthcare professional(s) involved in providing and/or supporting the care of the patient.

Although primarily depicted and described as being a single HDS 136, it will be appreciated that such patient data may be stored in any suitable number of systems. For example, patient personal information and medical history information may be stored in one or more patient information databases, test results may be stored in one or more databases dedicated to storing test results, contact information of healthcare professionals (e.g., for use in providing one or more location-based services to the healthcare professions) may be stored in a hospital employee tracking information database, and the like, as well as various combinations thereof. In this manner, HDS 136 represents the availability of patient data to LBSS 135, tablets 120, and/or any other devices which may access and utilize such information for providing various aspects of the location-based healthcare capability.

The HSSs 137 include servers supporting location-based services which may be provided for tablets 120. For example, the HSSs 137 may include data servers, audio conferencing servers, video conferencing servers, conference bridging servers, presence tracking servers, and the like, as well as various combinations thereof. The HSSs 137 also may include or have access to various databases storing information which may be used for providing such services (omitted for purposes of clarity). The HSSs 137 may support various services, such as delivery of location-based patient information, location-based click-to-call services, location-based phone selection services, location-based contact services, location-based message delivery services, location-based presence services, location-based inbound call routing services, location-based push-to-talk services, location-based automatic call setup services, location-based recording services, and the like, as well as various combinations thereof. The various types of servers, and associated services supported by those servers, which may form part of HSSs 137 may be better understood by way of reference to the various use cases described herein.

As depicted in FIG. 1, various networks, systems, and/or devices of hospital 101 may support connectivity to an external communications and services infrastructure 140 which is located outside of hospital 101. The external communications and services infrastructure 140 includes a bridging communication network 142 which provides access to external systems 144 and external communication networks 146.

In one embodiment, connectivity 119 is supported between patient rooms 110 and bridging communication network 142. The connectivity 119 may be used for any suitable purposes, such as for supporting communications between devices of the patient rooms 110 and bridging communication network 142. The devices for which connectivity 119 may be supported may include telephones located within the patient rooms 110, locator devices 111 located within the patient rooms 110 (e.g., where indoor location determination is performed remotely), medical equipment that supports network communication capabilities (e.g., for remote logging of medical data monitored and captured by medical equipment), and the like, as well as various combinations thereof. The connectivity 119 includes wireline and/or wireless connectivity, and may utilize any suitable communications technologies.

In one embodiment, connectivity 129 is supported between tablets 120 and bridging communication network 142. The connectivity 129 may be used for any suitable purposes, such as for supporting various location-based communications services associated with the location-based healthcare capability. For example, connectivity 129 may be used for supporting voice communications, video-based communications, conferencing, messaging, data retrieval, and the like, as well as various combinations thereof. The connectivity 129 includes wireless connectivity (e.g., WiFi, 3G, 4G, and the like) and, optionally, also may include wireline connectivity (e.g., where the tablets 120 may be docked or otherwise connected).

In one embodiment, connectivity 139 is supported between hospital communications and services infrastructure 130 (e.g., via hospital LAN 132) and bridging communication network 142. The connectivity 139 may be used for any suitable purposes, such as for supporting various location-based communications services associated with the location-based healthcare capability. For example, connectivity 129 may be used for supporting voice communications, video-based communications, conferencing, messaging, data delivery, and the like, as well as various combinations thereof. The connectivity 139 includes wireline and/or wireless connectivity, and may utilize any suitable communications technologies.

As depicted in FIG. 1, bridging communication network 142 provides access from various networks, systems, and/or devices of hospital 101 to any other external systems 144 and/or any other external communication networks 146 which may be utilized for providing the various location-based data and services depicted and described herein. For example, such external systems 144 may include patient data server systems (e.g., private health record servers located at other hospitals, public health record systems, and the like), communications services systems (e.g., voice conferencing servers, video conferencing servers, presence servers, and the like), and the like, as well as various combinations thereof. Similarly, for example, such external communication networks 146 may include any communication networks supporting the various location-based data and service delivery embodiments depicted and described herein.

Although primarily depicted and described herein with respect to specific types, numbers, and arrangements of rooms, devices, networks, and other related elements, it will be appreciated that any other suitable types, numbers, and/or arrangements of rooms, devices, networks, and/or other related elements may be used for providing the location-based healthcare capability.

FIG. 2 depicts a high-level block diagram illustrating one embodiment of a tablet of FIG. 1.

As depicted in FIG. 2, the tablet 120 includes a processor 210, a memory 220, communications interfaces 230, an input-output (I/O) interface 240, a presentation interface(s) 242, and a user control interface(s) 244. The processor 210 is coupled to each of memory 220, communication interfaces 230, and I/O interface 240. The I/O interface 240 is coupled to presentation interface(s) 242 for presenting information on tablet 120 and is coupled to user control interface(s) 244 for enabling user control of tablet 120.

The processor 210 is configured for controlling the operation of tablet 120 to provide the location-based healthcare capability.

The memory 220 is configured for storing information suitable for use in providing the location-based healthcare capability. For example, memory 220 may store programs 221, data 222, and the like. For example, programs 221 may include one or more location determination programs (e.g., a location information collection algorithm, and, optionally, a location determination algorithm), one or more location-based data control programs (e.g., for presenting location-based data, for facilitating interaction with location-based data, for supporting one or more location-based services, and the like), and the like, as well as various combinations thereof. For example, data 222 may include location determination information, patient data (e.g., patient information, information for providing location-based services, and the like), and the like, as well as various combinations thereof. The memory 220 may store any other information suitable for use by tablet 120 in providing the location-based healthcare capability.

The communications interfaces 230 include a location signaling interface (illustratively, for supporting location signaling 125 between tablet 120 and locator devices 111 of patient rooms 110) and one or more services signaling interfaces (illustratively, for supporting data/services signaling 126 between tablet 120 and systems of hospital communications and services infrastructure 130, and for supporting data/services signaling 129 between tablet 120 and external communications and services infrastructure 140). For example, the communications interface(s) 230 may include a Bluetooth-based location signaling interface 231, a WiFi-based service signaling interface 232, a 3G-based service signaling interface 233, and a 4G-based service signaling interface 234. It will be appreciated that fewer or more, as well as different, communications interfaces may be supported.

The I/O interface 240 provides an interface to the presentation interface(s) 242 and user control interface(s) 244 of tablet 120.

The presentation interface(s) 242 include any presentation interface(s) suitable for use in presenting information related to location-based data and services received at tablet 120. For example, the presentation interface(s) 242 may include a display screen, one or more speakers, and the like, which may be used for displaying patient data, displaying video, playing audio, and the like, as well as various combinations thereof. The typical presentation interfaces of tablet devices, including the design and operation of such interfaces, will be understood by one skilled in the art.

The user control interface(s) 244 include any user control interface(s) suitable for use in enabling the user of the tablet 120 to interact with the tablet 120. For example, the user control interfaces(s) 244 may include touch screen based user controls, stylus-based user controls, a keyboard and/or mouse, voice-based user controls, and the like, as well as various combinations thereof. The typical user control interfaces of tablet devices, including the design and operation of such interfaces, will be understood by one skilled in the art.

Although primarily depicted and described as having specific types and arrangements of components, it will be appreciated that any other suitable types and/or arrangements of components may be used for tablet 120. The tablet 120 may be implemented in any manner suitable for enabling delivery of location-based data and services to a user of the tablet 120.

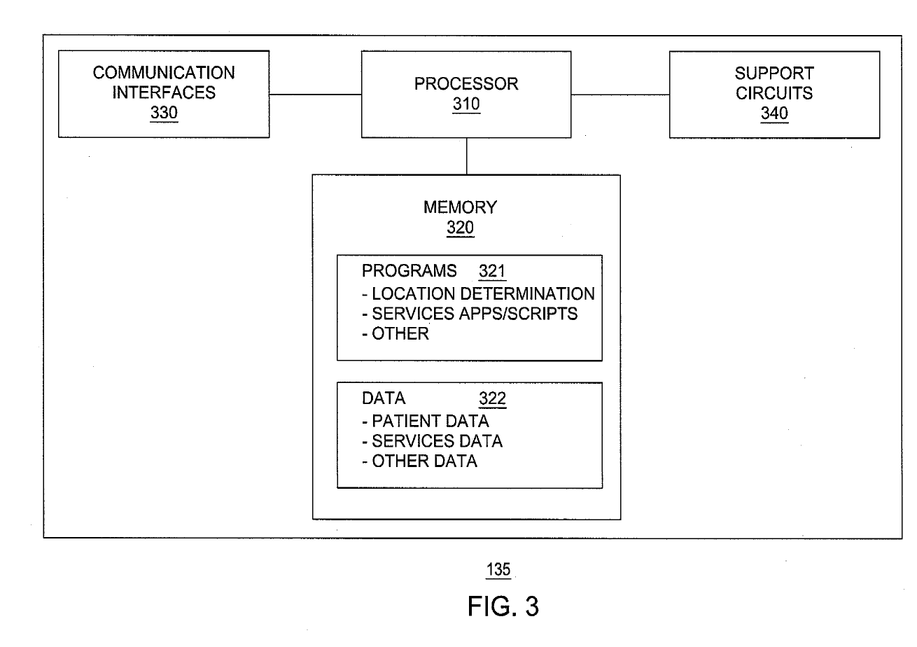

FIG. 3 depicts a high-level block diagram illustrating one embodiment of the LBSS of FIG. 1.

As depicted in FIG. 3, LBSS 135 includes a processor 310, a memory 320, communications interfaces 330, and support circuits 340. The processor 310 is coupled to each of memory 320, communication interfaces 330, and support circuits 340.

The processor 310 is configured for controlling the operation of LBSS 135 to provide the location-based healthcare capability.

The memory 320 is configured for storing information suitable for use in providing the location-based healthcare capability. For example, memory 320 may store programs 321, data 322, and the like. For example, programs 321 may include a location determination program, one or more applications and/or scripts which may be invoked for providing location-based data and/or services (e.g., for providing patient information to tablets 120 upon detection that the tablets 120 have entered patient rooms 110, for providing patient information to tablets 120 in response to requests for additional patient information received from tablets 120, for initiating establishment of voice calls upon receiving requests from tablets 120 indicative of selection of click-to-call links via tablets 120, for providing location/presence information to tablets 120 in response to requests for such information from tablets 120, for providing inbound call routing based on inbound call routing rules established for users of tablets 120, for initiating establishment and/or use of connections upon receiving requests from tablets 120 indicative of selection of push-to-talk links via tablets 120, for initiating automatic call establishment signaling upon detection that the tablets 120 have entered patient rooms 110, and the like), and the like, as well as various combinations thereof. For example, data 322 may include location determination information (e.g., mappings of radiators to hospital locations, mappings of patients to patient rooms, and the like), patient data (e.g., patient information, information for providing location-based services, and the like), and the like, as well as various combinations thereof. The memory 320 may store any other information suitable for use by LBSS 135 in providing the location-based healthcare capability.

The communications interfaces 330 may included any wireless and/or wireline interfaces configured for enabling communications by LBSS 135 with other elements, of exemplary environment 100. For example, communications interfaces 330 may include an interface to hospital LAN 132. The interface to hospital LAN 132 may be used for enabling communication between LBSS 135 and tablets 120 (e.g., such as where hospital LAN 132 supports wireless access point for enabling wireless access by tablets 120 to hospital LAN 132 and, thus, LBSS 135). The interface to hospital LAN 132 may be used for enabling communications between LBSS 135 and other systems (e.g., HDS 136, HSSs 137, various elements of external communications and services infrastructure 140, and the like). The communications interface(s) 330 may include any other suitable communication interfaces utilizing any suitable communications technologies.

Although primarily depicted and described as having specific types and arrangements of components, it will be appreciated that any other suitable types and/or arrangements of components may be used for LBSS 135. The LBSS 135 may be implemented in any manner suitable for enabling delivery of location-based data and services to tablets 120.

Returning now to FIG. 1, a description of an exemplary embodiment, for delivery of location-based data and services to a tablet 120 of a doctor within exemplary environment 100, follows. it will be appreciated that this embodiment is only exemplary and, thus, that various modifications may be made in accordance with other portions of the description provided herein.

A doctor is issued a tablet 120 which the doctor will carry while caring for patients, e.g., to view patient data of patients, to communicate with various parties associated patients, and the like.

A doctor may have to log into his or her tablet 120, so as to fully assure security and prevent unauthorized use of the tablet 120 for access to private medical data and other private patient information. The use of a login in this manner will be understood, as will the various ways in which subsequent login by the doctor may be managed. In one embodiment, for example, login by the doctor may be maintained for a predetermined length of time (e.g., 12-hours, 24-hours, the length of the doctor's shift, and the like), so as to prevent the doctor from having to log in repeatedly. In one embodiment, for example, the doctor may be required to log in again each time the tablet 120 enters a sleep mode. In one embodiment, the doctor may be assigned a single sign-on username and password associated with LBSS 135, even though various hospital systems and databases require separate usernames and password. It will be appreciated that any other login-based security measures may be used.

As a doctor moves about the hospital 101 carrying a tablet 120, the tablet 120 interacts with locator devices 111 of the patient rooms 110 which the healthcare professional enters or passes near. The result of the interaction between the tablet 120 and locator devices 111 is processed for identifying the indoor location of the tablet 120 and, thus, the indoor location of the doctor who is carrying the tablet 120. As described herein, the locator devices 111 may be radiator devices or detector devices and, similarly, tablets 120 may include detector devices (e.g., where locator devices 111 are radiator devices) and/or radiator devices (e.g., where locator devices 111 are detector devices). In one embodiment, a location determination algorithm is executed for tracking the location of the tablet 120 as the doctor moves about the hospital 101. The location determination algorithm for determining the indoor location of a tablet 120 may be executed by the tablets 120, the locator devices 111, one or more systems of hospital communications and services infrastructure 130, and the like, as well as various combinations thereof.

In this manner, when the doctor enters a particular room 110 in which a patient is located, the presence of the doctor within that room 110 is ultimately determined by LBSS 135 (e.g., via reporting by the tablet 120 where the tablet 120 executes the indoor location determination algorithm, via execution of the indoor location determination algorithm by LBSS 135, and the like). The LBSS 135, upon determining that the doctor is located within that particular room 110, determines the patient that is currently located in that particular room 110 (e.g., via a local mapping of rooms to patients available on LBSS 135, via one more systems accessible via hospital LAN 132, and the like). The LBSS 135 then controls delivery of location-based data and services to the tablet 120 based on the determined location of the doctor and, thus, based on the patient located within the room in which the doctor is located.

The LBSS 135 controls delivery of location-based data and services to the tablet 120.

The LBSS 135 controls delivery of location-based data to the tablet 120. The location-based data delivered to the tablet 120 may include any suitable patient data, such as patient information associated with the patient, information configured for use in supporting various location-based services which may be supported for the doctor via the tablet 120 (e.g., indications of telephone selection rules, associations of telephone numbers with click-to-call links, information on locations of other healthcare professionals, message delivery rules, rules for establishment of push-to-talk connections, and the like), and the like, as well as various combinations thereof. The patient data may be provided to the tablet 120 from any suitable source(s) of such data. For example, LBSS 135 may retrieve patient data for the patient locally and/or from one or more other systems, such as hospital systems 134 and/or external systems 144, and deliver the patient data to the tablet 120. For example, LBSS 135 may instruct one or more other systems (e.g., hospital systems 134 and/or external systems 144) to deliver patient data to the tablet 120. The LBSS 135 may perform various other functions, as well as various combinations thereof. The patient data may be delivered in any suitable manner. In one embodiment, for example, patient data may be delivered using Asynchronous Notification of location-based data.

The LBSS 135 controls delivery of location-based services to the tablet 120. The location-based services delivered to the tablet 120 may be supported by LBSS 135 in any suitable manner, which may vary for different types of services.

In one embodiment, at least a portion of the location-based services are made available via tablet 120 via delivery of location-based data configured for use by tablet 120 in accessing and using various location-based services (e.g., as described above with respect to use of location-based data to support location-based services).

In one embodiment, at least a portion of the location-based services are made available via tablet 120 based on interaction of the doctor with location-based data delivered to the tablet 120 and presented to the doctor via the tablet 120 (e.g., via interaction by the tablet 120 with LBSS 135 for requesting various services, via interaction by tablet 120 with HDS 136 and/or HSSs 137 for requesting various services (which may be direct interaction and/or indirect interaction via LBSS 135), and the like, as well as various combinations thereof.

In one embodiment, at least a portion of the location-based services are made available via interaction of LBSS 135 with one or more other systems for configuring the other system(s) to support location-based services for the tablet 120 (e.g., configuration of a voice conferencing server to support bridging of call legs, configuration of a presence server to track the presence of the doctor, configuration of a messaging server to support delivery of messages for the doctor based on the location of the doctor, configuration of a call routing server to support call routing rules for the doctor based on the location of the doctor, and the like, as well as various combinations thereof).

In one embodiment, LBSS 135, upon obtaining location-based data for a patient, formats the location-based data in a format for presentation via the tablet 120.

The formatting of location-based data may include formatting of patient information for presentation via tablet 120. The formatting of location-based data may include processing patient information and information configured for use in supporting various location-based services which may be supported for the doctor via the tablet 120 in a manner for associating these type of information such that they are integrated when presented via tablet 120.

For example, LBSS 135, upon obtaining patient information for the patient (e.g., personal information, medical records, test results, and the like), and determining names and contact information of parties relevant to the patient (e.g., other doctors and nurses, lab technicians, family members and friends, and the like), creates associations between the patient information and the information associated with the parties relevant to the patient. The associations may be in the form of control mechanisms (e.g., links, icons, and the like) embedded within, overlaid upon, and/or otherwise associated with patient information (e.g., at appropriate locations within the patient information to be displayed via tablet 120). For example, LBSS 135 may create click-to-call links linked to family members and friends and embed the links on a page including the medical information chart of the patient. For example, LBSS 135 may create click-to-call links linked to other doctors caring for the patient and embed the links on a page including the basic medical chart of the patient. For example, LBSS 135 may create a click-to-call link to a blood test technician which performed a blood test for the patient and a hematologist which analyzed the results of the blood test, and embed the links on a page including a blood test report for the patient. For example, LBSS 135 may create a click-to-conference link to other doctors and nurses associated with caring for the patient, and embed the link on a page including basic medical information for the patient. For example, LBSS 135 may create a push-to-talk link for enabling the doctor to immediately speak to the Nurse Station and embed the link on a page including basic medical information for the patient. It will be appreciated that the foregoing examples are merely a few examples of the way in which LBSS 135 may merge location-based data with various control mechanisms (e.g., links, icons, other widgets, and the like) in order to enable support for location-based services such as click-to-call, click-to-conference, location/presence tracking, push-to-talk, and the like, as well as various combinations thereof.

In one embodiment, LBSS 135, in response to obtaining location-based data for a patient, propagates the location-based data to the tablet 120 in an unformatted manner (e.g., not as one or more graphical pages to be presented at the tablet 120). In this embodiment, the tablet 120 formats the location-based data in a format for presentation via the tablet 120. In this embodiment, the tablet 120 may process the received location-based data for presentation via the tablet 120 in any suitable manner (e.g., using processing similar to that described with respect to LBSS 135 and/or any other suitable processing techniques).

The LBSS 135 may control delivery of location-based services to the tablet 120 in any other suitable manner.

The tablet 120, upon receiving location-based data, presents one or more alerts configured for notifying the doctor to the availability of the location-based data and services associated with the patient of the room that the doctor entered. The alert(s) may be any suitable type(s) of alert(s), e.g., one or more of a visual popup message on the tablet 120, an audible alert played by the tablet 120, and the like, as well as various combinations thereof.

The tablet 120, upon detecting that the doctor acknowledges the alert, presents at least a portion of the location-based data for use by the doctor in caring for the patient.

The doctor may acknowledge the alert, thereby indicating that the doctor would like access to location-based data for the patient, in any suitable manner. For example, the doctor may touch a link on a main screen of the tablet 120 in order to indicate that the doctor would like to access the location-based data for the patient. For example, the doctor may issue a voice command requesting access to the location-based data for the patient. It will be appreciated that any other suitable mechanism for requesting access to location-based data for the patient may be used.

The location-based data may be organized and presented in any suitable manner, as described herein. Similarly, the doctor may navigate, and interact with, the location-based data in any suitable manner.

As the doctor navigates the patient data presented via tablet 120, the doctor may request to view patient data, select various links which may trigger various types of communications (e.g., voice calls, push-to-talk connections, and the like), and the like. The selection of such data, links, and other controls may result in local processing to perform the requested action (e.g., display other patient data already downloaded and stored on tablet 120, initiate communications directly from tablet 120, and the like) and/or issuance of remote requests to perform the requested action (e.g., sending a message to LBSS 135 requesting establishment of a voice call, sending a message to LBSS 135 requesting use of a push-to-talk connection, and the like).

In at least some such embodiments, when the doctor selects various controls via tablet 120, tablet 120 may propagate associated requests to LBSS 135 (e.g., requests for additional patient data, requests for use of various communications services, and the like). The LBSS 135, upon receiving such requests, may handle the requests in any suitable manner. For example, LBSS 135 may respond to the request directly, issue suitable API commands via hospital LAN 132 to the appropriate HDS 136 and/or HSSs 137, issue suitable requests to systems via hospital LAN 132 and external communications and services infrastructure 140, and the like, as well as various combinations thereof.

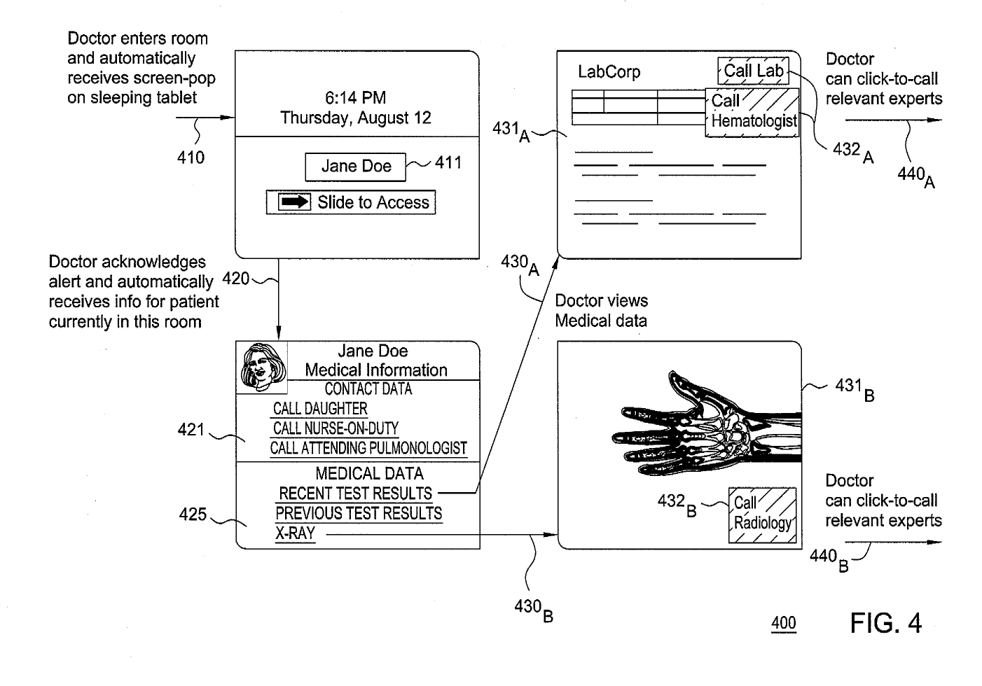

As described herein, the location-based data may be organized and presented in any suitable manner, as described herein. Similarly, the doctor may navigate, and interact with, the location-based data in any suitable manner. An exemplary display of location-based data via a tablet 120 is depicted and described with respect to FIG. 4.

FIG. 4 depicts an exemplary use of a tablet of FIG. 1 for accessing and utilizing location-based data and services. As depicted in FIG. 4, exemplary use 400 of a tablet 120 for accessing and utilizing location-based data and services is depicted and described within the context of the information that is displayed on the tablet 120 at various points in the process.

At step 410, a doctor enters a room 110 carrying the tablet 120 and automatically receives a pop-up message 411 on the sleeping tablet 120, which alerts the doctor to the availability of location-based data associated with the patient currently residing in that room 110. The pop-up message 411 may be a specific pop-up message including the name of the patient or may be a generic pop-up message indicating availability of information for whichever patient is located in that room 110. As depicted in FIG. 4, the main screen of tablet 120 may display any other suitable content (e.g., date, time, a wallpaper background, and the like, as well as various combinations thereof).

At step 420, the doctor acknowledges the pop-up message and automatically receives initial patient data associated with the patient. In one embodiment, for example, the initial patient data associated with the patient includes basic information such as a Contact Data section 421 and a Medical Data section 425. For example, the Contact Data section 421 may include click-to-call links to various parties associated with the patient (e.g., illustratively, a “call daughter” link, a “call nurse-on-duty” link, and a “call attending pulmonologist” link). For example, the Medical Data section 425 may include links to various types of medical data of the patient (e.g., illustratively, a “recent test results” link, a “previous test results” link, and an “x-rays” link). It will be appreciated that use of Contact Data section 421 and Medical Data section 425 are merely exemplary, and that any other suitable patient data may be presented using any other suitable arrangement(s) of such data.

At step 430_{A}, the doctor selects the “recent test results” link from Medical Data section 425, thereby resulting in display of a recent lab report 431_{A}. As depicted in FIG. 4, the recent lab report 431_{A} has two click-to-call links 432_{A} embedded therein (illustratively, a “call lab” link for enabling the doctor to click to call the lab at which the test was performed and a “call hematologist” link for enabling the doctor to click to call the hematologist responsible for analyzing the test results). At step 440_{A}, the doctor selects one of the click-to-call links 432_{A} embedded within recent lab report 431_{A}, thereby resulting in establishment of a voice call with the relevant party (e.g., via a telephone or VoIP capability of tablet 120, via a cell phone of the doctor, via a phone located in the room 110, and the like).

At step 430_{A}, the doctor selects the “x-rays” link from Medical Data section 425, thereby resulting in display of an x-ray 431 _{B}. As depicted in FIG. 4, the x-ray 431_{B} has a click-to-call link 432_{B} embedded therein (illustratively, a “call radiologist” link for enabling the doctor to click to call the radiologist associated with the x-ray 431 _{B}). At step 440_{B}, the doctor selects the click-to-call links 432_{B} embedded within x-ray 431_{B}, thereby resulting in establishment of a voice call with the relevant party (e.g., via a telephone capability of tablet 120, via a cell phone of the doctor, via a phone located in the room 110, and the like).

It will be appreciated that this exemplary use of the tablet 120 for accessing and utilizing location-based data and services is exemplary and, thus, that the doctor may be notified of the availability of location-based data in any other suitable manner, the doctor may interact with the tablet 120 in any other suitable manner, other types of location-based data may be displayed in any other suitable manner, and the like, as well as various combinations thereof.

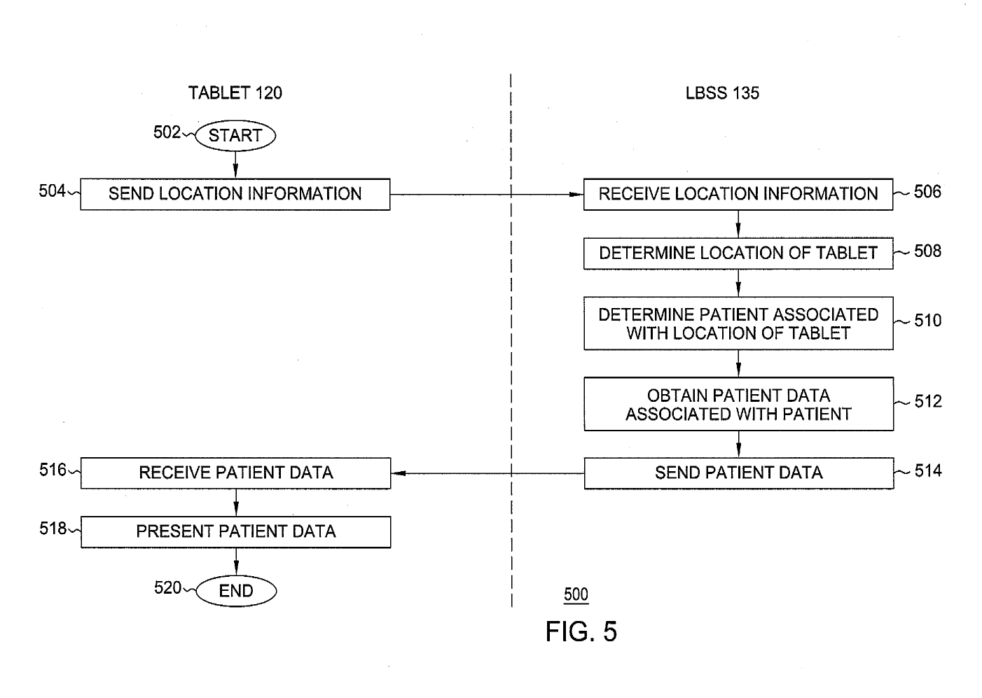

FIG. 5 depicts one embodiment of a method for delivery of location-based data and services to a tablet of FIG. 1.

At step 502, method 500 begins.

At step 504, the tablet 120 sends location information to LBSS 135. The tablet 120 sends location information in response to determining that the tablet 120 has entered a room, periodically for use by the LBSS 135 for determining whether the tablet 120 is located in a room, and the like. The location information may include a determined location of the tablet 120 (e.g., determined by the tablet 120 based on interaction with radiators located within the rooms) or information suitable for use by LBSS 135 in determining the location of the tablet 120. At step 506, LBSS 135 receives the location information. At step 508, LBSS 135 determines the location of the tablet 120 (e.g., by reading the location from the message received from tablet 120, by processing location information included within the message received from tablet 120, or in any other suitable manner).

At step 510, the LBSS 135 determines the patient associated with the location of the tablet 120. At step 512, the LBSS 135 obtains patient data associated with the patient. At step 514, the LBSS 135 sends the patient data to the tablet 120. At step 516, the tablet 120 receives the patient data from LBSS 135. At step 518, the tablet 120 presents the patient data.

In one embodiment, the patient data may be formatted into the desired format by the LBSS 135, and sent to the tablet 120 in this format for presentation via tablet 120.

In one embodiment, the patient data may be sent from LBSS 135 to tablet 120 as unformatted patient data which may then be processed by tablet 120 for formatting the patient data into the desired format for presentation via tablet 120.

At step 520, method 500 ends. Although depicted and described as ending (for purposes of clarity), it will be appreciated that (1) the tablet 120 will continue to operate to response to interactions by the doctor with the presented patient data as well as to provide various other functions depicted and described herein and (2) the LBSS 135 will continue to operate to respond to other requests for patient data as well as to provide various other functions depicted and described herein.

Although primarily depicted and described with respect to interaction between the tablet 120 and the LBSS 135 for providing the location-based healthcare capability, it will be appreciated that, as described herein, tablet 120 and/or LBSS 135 may interact with various other devices for providing various aspects of the location-based healthcare capability.

The many types of location-based data and services which may be provided and accessed in accordance with the location-based healthcare capability may be better understood by way of reference to descriptions of exemplary use cases which may be supported using the location-based healthcare capability, which follow. Although these exemplary use cases are primarily described within the context of embodiments in which location-based data and services are used by doctors (e.g., provided to doctors and/or used by doctors to interact with other doctors), it will be appreciated that various embodiments of these exemplary use cases may be used to provide the location-based data and services to other types of healthcare professionals in addition to and/or in place of doctors (e.g., provided to any healthcare professional(s) and/or used by any healthcare professional(s) to interact with any other healthcare professional(s)). Although these exemplary use cases are primarily described herein within the context of embodiments in which the location-based healthcare capability is provided within a hospital setting, it will be appreciated that these use cases also may be adapted for use within any suitable type of healthcare environment (e.g., doctor offices, clinics, and the like).

In one embodiment, the location-based healthcare capability supports delivery of location-based patient data. The patient data for a patient is delivered to the tablet 120 and presented via the tablet 120 for use by the doctor in caring for the patient. As described herein, the patient data may include any suitable patient data, such as patient information (e.g., personal information of the patient, medical history, current medical information, and the like), information for use in providing location-based services, and the like, as well as various combinations thereof. As also described herein, the patient data may be presented in any suitable manner (e.g., with any suitable granularity, in any suitable format, and the like). As also described herein, the doctor may navigate the user interface of tablet 120, for accessing the patient data, in any suitable manner.

In one embodiment, only a subset of the patient data delivered to the tablet 120 for use by the doctor is actually, at least initially, presented to the doctor via the tablet 120. In one such embodiment, for example, the most relevant medical information for the patient is presented to the doctor initially (e.g., upon the doctor simply touching a link on a main page). In such embodiments, the doctor may then access other patient data (i.e., delivered but not initially presented and/or not delivered) in any suitable manner (e.g., by navigating within the user interface of the tablet 120, which may result in retrieval of additional patient data previously delivered to the tablet 120 and/or which may result in requests for additional patient data not initially delivered to the tablet 120).

In one embodiment, only a subset of the patient data associated with the patient is delivered to the tablet 120 for use by the doctor.

In one embodiment, the subset of patient data that is delivered to the tablet 120 for use by the doctor may be based on his or her role or specialty (e.g. cardiologists receive information about blood pressure, hematologists could receive information about white blood cell count, and the like).

In one embodiment, the subset of patient data that is delivered to the tablet 120 for use by the doctor may be based on subscription information associated with the doctor. The doctor may set/modify his or her subscription in any suitable manner, e.g., via the tablet 120 (e.g., via a link, menu option, and/or any other suitable control mechanisms), via another computer or smartphone (e.g., where the doctor logs into his or her account), and the like.

In one embodiment, the doctor may receive patient data updates for the patient in response to any suitable trigger condition(s). In one embodiment, the trigger condition is detection that the doctor has entered the room of the patient or a nearby room (i.e., delivery of location-based patient data, as depicted and described herein). In one embodiment, the trigger condition may be one or more of when the dataset changes (e.g., new lab results are received), when a monitored level crosses a threshold (e.g. real-time monitoring data indicates a significant change in condition), when location-based services information changes (e.g., when a new nurse is on duty, when presence information changes, and the like), and the like, as well as various combinations thereof. In one such embodiment, the doctor may only receive such patient data updates as long as the doctor is still determined to be located within the patient's room.

In one embodiment, in which multiple patients are located in a single room, the doctor is automatically presented with multiple links associated with the multiple patients, thereby enabling the doctor to access patient data for the patient of interest by simply selecting the link associated with the patient of interest.

The delivery of location-based patient data may include any other suitable types of patient data which may be presented in any other suitable manner in response to any other suitable trigger condition(s).

In one embodiment, the location-based healthcare capability supports location-based click-to-call links.

The click-to-call links may be displayed for enabling the doctor to click-to-call to speak with a selected party or parties (e.g., one or more of another doctor who is associated with the patient, a nurse(s) currently on duty for the patient, a member of the patient's family, and the like).

The click-to-call links may be presented in any suitable manner (e.g., in any suitable location(s), using any suitable icons for the click-to-call links, and the like). The presentation of click-to-call links may depend, at least in part, on the party or parties with which the click-to-call links are associated. For example, click-to-call links may be displayed on the main page of the tablet 120 (e.g. for click-to-call links for members of the patient's family, click-to-call links for doctors and nurses, and the like). For example, click-to-call links may be displayed such that they are integrated with, or otherwise associated with, patient medical data displayed on the tablet 120 (e.g., display of a click-to-call link to a lab technician on an x-ray displayed on tablet 120, display of a click-to-call link to a blood laboratory technician or hematologist associated with a blood test result chart displayed on tablet 120, and the like, as well as various combinations thereof). The click-to-call links may be displayed on tablet 120 in any other suitable manner.

In one embodiment, in which multiple parties are identified as being associated with the patient, the LBSS 135 may propose a best-set of click-to-call links which may be presented by tablet 120. The best-set of click-to-call links may be a subset of the full set of click-to-call links available for the patient, a particular arrangement of click-to-call links displayed on tablet 120, and the like, as well as various combinations thereof.

The establishment of a call in response to selection of a click-to-call link may be performed in any suitable manner. In one embodiment, for example, upon selection of a click-to-call link displayed on the tablet 120 by the doctor carrying the tablet 120, a phone of the doctor is called (denoted as the first leg) and a phone of the selected party is called (denoted as the second leg), and the two legs of the call are then bridged together to establish the connection.

In such embodiments, the phone of the doctor may be any suitable device of the doctor (e.g., the tablet 120, a phone of the room in which the doctor is located, a cell phone of the doctor, and the like) and, similarly, the phone of the selected party may be any suitable device of the selected party.

In at least some such embodiments, LBSS 135 determines the actual telephone numbers to be called in order to complete the call legs and, thus, establish the connection. The LBSS 135 may determine the telephone numbers in any suitable manner. In one embodiment, the LBSS 135 may determine the telephone numbers from one or more of the hospital systems 134. For example, when a doctor touches a click-to-call link to call the nurse who is currently on duty for the patient, LBSS 135 might first interact with a system or database to determine the name of the nurse currently on duty for the patient, use the same or a different system or database to look up the telephone number of the nurse, and then subsequently initiate call setup for this leg of the call using the determined telephone number.

In one embodiment, for example, LBSS 135, when obtaining location-based data for the patient, determines the names and telephone numbers of other people relevant to the patient, creates links to the location-based data (e.g., a click-to-call link for each relevant person), and provides the click-to-call links to the tablet 120 via an Asynchronous Notification Message. In this embodiment, when the doctor selects one of the click-to-call links via the tablet 120, an indication of the selection of the click-to-call link is propagated from tablet 120 to LBSS 135, and LBSS 135 issues suitable API commands via hospital LAN 132 to a voice conferencing server in order to establish the call requested via selection of the click-to-call link.

In such embodiments, use of click-to-call links simplifies the workflow of the healthcare professionals by facilitating voice communications of healthcare professionals providing and/or supporting patient care (e.g., by obviating the manual telephone number lookup process currently used by healthcare professionals), thereby improving overall patient care.

An exemplary embodiment of location-based click-to-call links is depicted and described with respect to FIG. 4.

In one embodiment, the location-based healthcare capability supports location-based phone selection. In one such embodiment, the location-based phone selection provides automatic selection of the phone to be used by the doctor. For example, when a doctor clicks-to-call by touching a link on the tablet 120, the phone selected for the doctor will be connected as a first leg of the intended call. The phone may be any phone associated with the doctor, e.g., the tablet 120 itself (e.g., a softphone software application running on tablet 120), a cell phone of the doctor, a phone located in the hospital room in which the doctor is located, or any other suitable phone accessible to the doctor. The phone to be used by the doctor may be pre-selectable and configurable by the doctor (e.g., some doctors might prefer that the first leg of the click-to-call is always directed to the softphone of the tablet 120, whereas some other doctors might prefer that the first leg of the click-to-call is always directed to their cell phone, whereas some other doctors might prefer that the first leg is always directed to the phone in the room in which the doctor is located). The phone to be used by the doctor may be selected on-the-fly using one or more parameters. For example, the phone to be used by the doctor may be selected based on one or more of the number of patients currently within the room in which the doctor is located (e.g., in rooms having only one patient the doctor may which to talk/listen using a speakerphone capability of the tablet 120, whereas in rooms having multiple patients the doctor may wish to use his or her cell phone or the phone in the room in which the doctor is located), the person/place to which the call is to be placed, the type of call being placed, and the like, as well as various combinations thereof.

In one embodiment, the location-based healthcare capability supports location-based contact of nearby doctors (and/or other types of healthcare professionals). In one such embodiment, a doctor is able to use the tablet 120 to determine which other doctors are nearby, e.g., by viewing one or more of a list, display, and/or map indicating nearby doctors. For example, a first doctor in Room 123 might observe that a second doctor is just down the hall in Room 127, thereby enabling the first doctor to walk over to Room 127 in order to consult with the second doctor since he or she is conveniently nearby. Similarly, for example, the first doctor might easily click-to-call the second doctor (e.g., where the list/display/map of nearby doctors includes a click-to-call link for the second doctor), who is already nearby, inquiring about the availability of the second doctor for a quick consult regarding the patient of the first doctor. it will be appreciated that the list/display/map of nearby doctors may be utilized by the doctor in other ways consistent with various other services and capabilities depicted and described herein. For example, in addition to ad-hoc medical consultations, being able to click-to-call the nearest specialist, surgeon, or other doctor might also be useful in emergency and code blue scenarios. It will be further appreciated that this usage of location-based data displayed on a portable device which can also establish voice communications is useful for establishing ad-hoc medical consultations, thereby improving overall patient care.

In one embodiment, the location-based healthcare capability supports delivery of location-based messages. in one embodiment, the delivery of location-based messages enables delivery of a message from one or more doctors to one or more other doctors based on location. For example, delivery of location-based messages enables a first doctor to leave a message, regarding a patient, for a second doctor, where the message is delivered to the second doctor upon the arrival of the second doctor at the room of the patient. For example, the message of the first doctor to the second doctor might be as follows: “Our patient Jane Doe has elevated blood pressure, so please reconfirm this and then call me to discuss our options.” In this example, when the second doctor later enters the room of that patient, the second doctor would receive the timely message, act upon it, and initiate the contact with the first doctor. In such embodiments, the messages may be any suitable message types (e.g., voice-based, text-based, and the like, as well as various combinations thereof) and, thus, may be presented in any suitable format (e.g., as an audio message, via visual display of a text of other message, and the like). In one embodiment, for example, upon arrival at a room having a patient for which a message has been recorded, the arriving doctor may be presented with a list of links to audio recordings (with optional voice-to-text transcriptions), of comments and findings recorded by previous medical personnel about this patient. In one embodiment, for example, upon arrival at a room having a patient for which a message has been recorded, a phone of the doctor (e.g., tablet 120, cell phone, and the like) may be called automatically such that the audio message then may be delivered via the established audio connection. In one such embodiment, following delivery of the message to the doctor, the doctor might be presented with various options for initiating a call to the person who created the message (e.g., by pressing a button, clicking a link, and the like). For example, following delivery of the message to the doctor, the doctor may be presented with an option such as “Press 1 to call back Doctor Smith about this message”.

In one embodiment, the location-based healthcare capability supports location-based presence services. In one such embodiment, the room location presence of a doctor is tracked for display to authorized subscribers.

For example, an administrative assistant of a doctor may determine, by viewing a display of presence information, that the doctor has just entered a certain room, which the administrative assistant may then use to perform various functions. For example, the administrative assistant could click-to-call the doctor (where the call may be routed to any suitable call device), forward incoming calls to the doctor via any suitable phone of the doctor, conference in other parties to speak with the doctor (e.g., concerned family members, other doctors, and the like), and the like, as well as various combinations thereof. In one embodiment, for example, a conference bridge may be used to display the location presence of various doctors as they move around the hospital to visit patients. In one such embodiment, the conference bridge may support a buddy list capability in which buddies of a particular doctor (e.g., subscribers authorized to view the location of that particular doctor) are able to view the location of the doctor and can then conveniently perform location-based presence actions using buddy-list driven actions (e.g., initiating a click-to-call the doctor via the buddy list, initiating a click-to-conference via the buddy list, and the like). In one such embodiment in which a conference bridge is used to provide or support the location-based presence services, a conference bridge such as the Alcatel-Lucent MyTeamwork system may be used. In such embodiments of the location-based presence services, the location-based presence information may be accessed and displayed via any suitable device, e.g., a tablet 120, a computer, a smartphone, and the like.

In one embodiment, the location-based healthcare capability supports location-based inbound call routing. In one embodiment, inbound calls to a doctor are suitably routed for the doctor based on the current location of the doctor. In one embodiment, for example, a doctor may wish to have all incoming calls routed to an administrative assistant whenever he or she is in a patient room (e.g., so as not to cause any disruption when dealing with the patients in the rooms), and to have all incoming calls routed to his cell phone whenever he or she is not in a patient room. In one embodiment, for example, a doctor may wish to only receive calls from certain parties (e.g., any granularity, such as depending on whether or not the doctor is located inside or outside of a patient room, depending on the specific room in which the doctor is located at the time of the incoming call, and the like). For example, the doctor may wish to only receive calls related to the care of a patient when located within the room of that patient, the doctor may wish to only receive calls from his or her administrative assistant when located within a room, and the like. In one embodiment, the doctor may opt to receive text transcriptions of incoming calls, which may be delivered to the tablet 120 via any suitable asynchronous notification mechanisms. It will be appreciated that these types of incoming call routing rules may be configured at any suitable time and in any suitable manner (e.g., preconfigured by the doctor, modified by the doctor on the fly via the tablet 120, and the like, as well as various combinations thereof).

In one embodiment, the location-based healthcare capability supports location-based push-to-talk. in one embodiment, for example, one or more push-to-talk software applications running on the tablet 120 may enable the doctor to establish voice sessions based on location. For example, when the doctor enters a particular room and presses a push-to-talk icon on his or her tablet 120, this may result in automatic delivery of the voice of the doctor to any other suitable location/device (e.g., to one or more nearby nurses stations for requesting assistance or other support, to the administrative assistant of the doctor, to one or more other doctors, to an overhead paging system of the hospital, and the like, as well as various combinations thereof). In one embodiment, selection of a push-to-talk icon by the doctor may result in automatic connection of the doctor to a voice-to-text transcription service that is configured for automatically associating the voice and text data to the patient in the room in which the doctor is located when the push-to-talk icon is selected.

In one embodiment, the location-based healthcare capability supports location-based automatic call setup. In one embodiment, for example, the arrival of a doctor into a room automatically initiates voice communication with one or more other people (e.g., one or more doctors, one or more members of the family of the patient that is located within the room, and the like, as well as various combinations thereof). In one such embodiment, a person (e.g., doctor, family member, and the like) can “tag” a doctor for a particular room, such that when the tagged doctor enters that room, a communication session (e.g., a voice conference, a chat session, and the like) is automatically established between the tagged doctor and the person who set the tag. In this embodiment, the communication session may be established to a device/number/account of choice of the tagged doctor (e.g., the tablet 120, the room phone, cell phone, and the like) and to a device/number/account of choice of the person who set the tag. In such embodiments, the tag may be set in any suitable manner (e.g., via an application available on the tablet 120 of a doctor setting the tag, by calling a designated number associated with the tagging service and leaving another number as a callback number, via text messaging, via email, and the like, as well as various combinations thereof).

In one embodiment, the location-based healthcare capability supports location-based recording. In one such embodiment, for example, a healthcare professional entering a patient room could choose to initiate an audio recording. The audio recording could be a recording of the conversation that takes place in the patient room, a recording based on single-party or multi-party voice calls (e.g., setup by the healthcare professional after touching one or more hyperlinks on the tablet 120 or by any other suitable mechanisms), and the like, as well as various combinations thereof. In one embodiment, audio recordings may be automatically tagged with information related to the recorded audio (e.g., the name of the patient which may be derived from automatic determination of the room location), the current date and time, the healthcare professional(s) participating in the recorded audio, and the like, as well a various combinations thereof. In such embodiments, the recorded audio would then be available to any authorized, interested party (e.g., to the healthcare professional associated with the tablet 120 on which the audio is recorded), to other authorized healthcare professionals, to members of the patient's family, and the like. In such embodiments, any of the authorized, interested parties may access the recorded audio from any suitable location (e.g., from the tablet 120 on which the audio was recorded, via Internet access where the recorded audio is stored such that it is accessible remotely via a communication network, and the like). It will be appreciated that other types of recordings may be supported.

From the foregoing embodiments and examples, it will be appreciated that these use cases are merely a few examples of the many possibilities, scenarios, and capabilities, as well as variations, familiar to those skilled in the art of hospital operations and medical workflows that can be significantly enhanced by usage of the location-based healthcare capability configured for providing location-based data and communication services in connected healthcare environments.

From the foregoing embodiments and examples, it will be appreciated that the location-based healthcare capability depicted and described herein provides various benefits for all interested parties, including but not limited to the hospital, the healthcare professionals caring for and/or supporting the care of the patients, the patients, families of the patients, and the like.

As described herein with respect to FIG. 1, implementations of the location-based healthcare capability may involve interaction between various elements.

As described herein, the location-based healthcare capability enables delivery of location-based data and services for a doctor based on the location of the doctor, which requires knowledge of the location of the doctor. In such embodiments, the location of the doctor is an indoor location of the doctor, such that GPS-based location may not be sufficient in most applications. The indoor location of a doctor may be determined in any suitable manner.

In a first embodiment, Bluetooth radiators are deployed within the hospital 101 (e.g., within each of the patient rooms 110 of the hospital 101 and, optionally, within other locations of the hospital 101), and the tablet 120 includes a Bluetooth radio configured for detecting/sniffing the Bluetooth radiators deployed within the hospital 101. In this embodiment, locator devices 111 are implemented as Bluetooth radiators.

In a second embodiment, Bluetooth radios are deployed within the hospital 101 (e.g., within each of the patient rooms 110 of the hospital 101 and, optionally, within other locations of the hospital 101) and each of the tablets 120 includes a low-cost Bluetooth radiator, and the Bluetooth radios are configured for detecting/sniffing the Bluetooth radiators deployed within the tablets 120 (i.e., detecting/sniffing the presence of tablets 120 within particular locations of the hospital 101, respectively). In this embodiment, locator devices 111 are implemented as Bluetooth radios.

The first embodiment reduces overall system cost by using low-cost room-based Bluetooth radiators at the expense of more complex algorithms running in the tablets 120 (which may result in a potentially shorter battery life of the tablets 120, due to continuous running of the algorithms in the background), whereas the second embodiment increases the overall system cost but does not require such complex algorithms to be running within the tablets (thereby resulting in longer battery lives of the tablets 120).

In such embodiments, the indoor location of the tablet 120 may be determined using raw signal information obtained from interaction between the Bluetooth radiators and the Bluetooth radio which detects the Bluetooth radiators. In one embodiment, an algorithm is used to process the raw signal information for determining the location of the tablet 120.

In one embodiment, the algorithm is executed by the tablet 120 (e.g., where the tablet 120 includes the Bluetooth radio and the Bluetooth radiators are deployed within the hospital). In one such embodiment, for example, the algorithm executing on the tablet 120 would access the Bluetooth radio of the tablet 120 in order to perform the Bluetooth radiator sniffing operations and the determine the location of the tablet 120 based on the raw signal information obtained from the Bluetooth radio. In this case, the tablet 120 determines its own location, and can send the determined location to LBSS 135 for use in providing the location-based data and services as depicted and described herein.

In one embodiment, the algorithm is executed in conjunction with Bluetooth radios deployed within the hospital (e.g., where the tablet 120 includes a Bluetooth radiator). In one such embodiment, for example, the algorithm executing in conjunction with the Bluetooth radio would access the Bluetooth radio in order to perform the Bluetooth radiator detecting/sniffing operations and determine the location(s) of tablet(s) 120 based on the raw signal information obtained from the Bluetooth radio. In this case, the Bluetooth radio or some other device associated with the Bluetooth radio determines the location(s) of tablet(s) 120 and sends the determined location(s) to LBSS 135 for use in providing the location-based data and services as depicted and described herein.

In one embodiment, the algorithm is executed by a central server.

In one embodiment, in which the tablet 120 includes the Bluetooth radio and the Bluetooth radiators are deployed within the hospital, the tablet 120 may collect the raw signal information and send it to the central server for use by the central server in determining the indoor location of the tablet 120. In one such embodiment, for example, an algorithm executing on the tablet 120 would access the Bluetooth radio of the tablet 120 in order to perform the Bluetooth radiator detecting/sniffing operations and to send the raw signal information obtained from the Bluetooth radio to the central server for use by the central server in determining the indoor location of the tablet 120. In this case, the central server determines the location of the tablet 120 for use in providing the location-based data and services as depicted and described herein.

In one embodiment, in which the tablet 120 includes a Bluetooth radiator and Bluetooth radios are deployed within the hospital, the Bluetooth radios may collect the raw signal information and send it to the central server for use by the central server in determining the indoor location of each of the tablets 120 located within the hospital. In one such embodiment, for example, algorithms executing in conjunction with the respective deployed Bluetooth radios perform Bluetooth radiator sniffing operations and send the raw signal information obtained from the Bluetooth radiators to the central server for use by the central server in determining the indoor locations of the tablets 120. In this case, the central server determines the locations of the tablets 120 for use in providing the location-based data and services as depicted and described herein.

In at least some such embodiments (e.g., those in which software is executed on the tablet 120 for enabling determination of the indoor location of the tablet 120), the real-time software routine in the tablet 120 continues to run in the background, even when the tablet 120 may be sleeping, so that the current location of the tablet 120 is always known for providing timely delivery of location-based data and services.

FIG. 6 depicts an exemplary environment for determining the indoor location of a tablet of FIG. 1 where the tablet includes a Bluetooth radio and the rooms of the hospital of FIG. 1 include Bluetooth radiators.

As depicted in FIG. 6, exemplary environment 600 includes a portion of hospital 101 of FIG. 1. Namely, exemplary environment 600 includes a hallway and three patient rooms 110 (illustratively, patient rooms 110_{N-1}, 110_{N}, and 110_{N+1}), where the patient rooms 110_{N-1}, 110_{N}, and 110_{N+1} include Bluetooth radiators 111_{N-1}, 111_{N}, and 111_{N+1}, respectively.

As further depicted in FIG. 6, a doctor carrying a tablet 120 enters one of the patient rooms 110 (illustratively, room 110_{N}). The tablet 120 includes a Bluetooth radio configured for detecting signaling from Bluetooth radiators. The tablet 120 also runs a Bluetooth sniffing algorithm periodically as a background task for detecting signaling from Bluetooth radiators.

In this case, even though the tablet 120 is located within room 110_{N}, the Bluetooth radio of tablet 120 detects Bluetooth signals not only from the Bluetooth radiator 111_{N} of room 110_{N}, but also from the Bluetooth radiators 111_{N-1} and 111_{N+1} of adjacent patient rooms 110_{N-1} and 110_{N+1}, respectively. Thus, tablet 120 must determine which of the patient rooms 110_{N-1}, 110_{N}, and 110_{N+1} in which the tablet 120 is currently located. In one embodiment, tablet 120 runs a location determination algorithm configured for processing the Bluetooth signaling received from 111_{N-1}, 111_{N}, and 111_{N+1} for determining which of the patient rooms 110_{N-1}, 110_{N}, and 110_{N+1} in which the tablet 120 is currently located. The algorithm used for determining the indoor location of the tablet 120 may be any suitable algorithm. An exemplary algorithm for determining the indoor location of the tablet 120 is depicted and described with respect to FIG. 7.

FIG. 7 depicts one embodiment of a method for determining the indoor location of a tablet of FIG. 1.

At step 702, method 700 begins.

At step 704, a determination is made as to whether the tablet was located within a room on the previous execution of method 700. This information may be maintained in any suitable location, which may depend on where method 700 is executed. If the tablet was located within a room on the previous execution of method 700, method 700 proceeds to step 716. If the tablet was located within a room on the previous execution of method 700, method 700 proceeds to step 706.

At step 706, Bluetooth radiator discovery is performed, for discovering any Bluetooth radiators within range of the tablet.

At step 708, each of the discovered Bluetooth radiators is polled for determining, for each of the discovered Bluetooth radiators, a signal strength of the Bluetooth radiator.

At step 710, a determination is made as to whether, for any of the discovered Bluetooth radiators, a signal strength of the Bluetooth radiator is above a threshold after a threshold number of tries (e.g., denoted as M tries).

If the signal strength of a discovered Bluetooth radiator is above a threshold after a threshold number of tries, method 700 proceeds to step 712. At step 712, a determination is made that the tablet is located within a room, and an identifier associated with the room is saved. The identifier associated with the room may be any suitable identifier, e.g., an identifier of the Bluetooth radiator which may be used to identify the associated room, an identifier of the room (e.g., which may be determined from a local memory of the tablet having a list of mappings of Bluetooth radiator identifiers to the rooms in which those Bluetooth radiators are located, and the like), and the like, as well as various combinations thereof. From step 712, method 700 proceeds to step 722, where method 700 ends.

If the signal strength of a discovered Bluetooth radiator is not above a threshold after a threshold number of tries, method 700 proceeds to step 714. At step 714, a determination is made that the tablet is not located within a room. From step 714, method 700 proceeds to step 722, where method 700 ends.

At step 716, the Bluetooth radiator of the room in which the tablet was previously located is polled for determining a signal strength of the Bluetooth radiator.

At step 718, a determination is made as to whether the signal strength of the Bluetooth radiator is above a threshold after a threshold number of tries (e.g., denoted as N tries).

If the signal strength of the Bluetooth radiator is not above a threshold after a threshold n number of tries, method 700 returns to step 706. If the signal strength of the Bluetooth radiator is above a threshold after a threshold number of tries, method 700 proceeds to step 720. At step 720, a determination is made that the tablet is still located within the same room, and an identifier associated with the room is saved. The identifier associated with the room may be any suitable identifier (e.g., as described with respect to step 712). From step 720, method 700 proceeds to step 722, where method 700 ends.

At step 722, method 700 ends.

In such embodiments, the signal strength of a Bluetooth radiator may be indicated using any suitable signal strength information. For example, the signal strength of a Bluetooth radiator may be indicated using a Received Signal Strength Indicator (RSSI) for the Bluetooth radiator or using any other suitable type of indicator(s).

Although depicted and described as ending, it will be appreciated that method 700 will continue to be executed by the tablet periodically to provide real-time tracking of the location of the tablet within the hospital.

Although primarily depicted and described herein with respect to embodiments in which Bluetooth signals are used as the basis for performing indoor location determination for tablets 120, it will be appreciated that any other suitable forms of wireless signaling may be used as the basis for performing indoor location determination for tablets 120. Accordingly, various references herein to Bluetooth, such as in FIGS. 1, 6, and 7, may be read more generally as also representing use of other types of wireless signaling for performing indoor location determination for tablets 120.

Although primarily depicted and described herein with respect to embodiments in which LBSS 135 is located within hospital 101 and serves only hospital 101, it will be appreciated that various other embodiments may be used.

In one embodiment, for example, although depicted and described as being a single system, the LBSS 135 may be implemented in a distributed manner within hospital 101, where distribution may be based on any suitable factor(s), e.g., based on location within the hospital 101 (e.g., using a different LBSS 135 for each wing or floor of the hospital 101 so as to provide load balancing), based on groups of healthcare professionals (e.g., each healthcare professional is assigned to use one of a plurality of LBSSs such that the entire universe of healthcare professional is distributed across multiple LBSSs 135), and the like, as well as various combinations thereof.

In one embodiment, for example, although depicted and described as being located within hospital 101, the LBSS 135 may be located outside of hospital 101 and serve only hospital 101. In this embodiment, LBSS 135 also may be implemented in a distributed manner outside of hospital 101.

In one embodiment, for example, although depicted and described with respect to embodiments in which LBSS 135 is located within hospital 101 and serves only hospital 101, in other embodiments one or more LBSSs 135 may be used to serve one or more hospitals.

In one embodiment, for example, a single LBSS 135 may be used to serve multiple hospitals.

In one embodiment, for example, multiple LBSSs 135 may be used to serve multiple hospitals (e.g., where each LBSS 135 serves a respective hospital, where a single LBSS 135 serves multiple hospitals, and the like, as well as various combinations thereof).

It will be appreciated that use of a centralized or distributed LBSS(s) 135 to support multiple healthcare locations is especially useful for doctors and/or other healthcare professionals having their own offices and operating within hospitals and for doctors and/or other healthcare professionals affiliated with multiple hospitals.

In at least some such embodiments, in which multiple LBSSs 135 are used, the multiple LBSSs 135 may be logically integrated such that, from the perspective of the healthcare professionals, a single LBSS 135 is accessible from all of the doctor's offices, hospitals, and other healthcare locations in which the healthcare professionals operate.

It will be appreciated that, in at least some such embodiments, the location determination, upon which delivery of location-based data and services is based, may include additional location information as appropriate. For example, where an LBSS 135 serves multiple hospitals, the location information for a healthcare professional, in addition to identifying a room location, may also identify the hospital in which the healthcare professional is located.

It will be appreciated that various other implementations may be used for supporting the functions of LBSS 135 for healthcare professionals. Although primarily depicted and described herein with respect to use of the location-based healthcare capability within the context of a hospital, it will be appreciated that various embodiments of the location-based healthcare capability may be utilized with any other suitable healthcare environment (e.g., medical centers, clinics, doctor offices, dentist offices, and the like).

Although primarily depicted and described herein within the context of healthcare, it will be appreciated that the principles of the location-based healthcare capability depicted and described herein may be used within various other types of environments in which delivery of location-based data and/or services may be useful.

In one embodiment, for example, delivery of location-based data and/or services may be provided for people who travel to customer locations to perform various types of tasks (e.g., heating/cooling technicians who travel to homes and businesses for heating and air conditioning work, landscapers who travel to homes and businesses to provide landscaping, plumbers and electricians who travel to homes and businesses for repairs and/or new work, and the like, as well as various combinations thereof). In this embodiment, upon arriving at a customer location, the customer location is detected and used to deliver data and/or services to the user device (e.g., tablet) of the person. For example, delivery of location-based data and/or services may result in display of a work order for the customer such that the person knows the work to be performed, automatic initiation of a telephone call to the customer such that the person can inform the customer that he or she has arrived and is ready to begin working, embedding of click-to-call links of previous technicians that have done work for the customer so that the current technicians can easily contact previous technicians for consultations, and the like, as well as various combinations thereof. In this embodiment, the identification of the customer locations may be performed in any suitable manner, e.g., using GPS capabilities, using indoor location determination capabilities depicted and described herein, and the like, as well as various combinations thereof. in one embodiment, in which indoor location determination capabilities depicted and described herein are used, the radiators may be affixed at or otherwise associated with the customer locations in any suitable manner, e.g., by affixing radiators to the buildings, by affixing radiators to devices within the buildings relevant to the person using the location-based capabilities (e.g., on a hot water heater for a hot water heater technician, on a power meter for a technician from the power company, and the like), and the like, as well as various combinations thereof.

In one embodiment, for example, delivery of location-based data and/or services may be provided for executives, e.g., at large enterprises, who travel around the enterprise campuses for meeting with various employees of the enterprise to discuss various issues. In this embodiment, upon arriving at an employee location, the employee location is detected and used to deliver data and/or services to the user device (e.g., tablet) of the executive. For example, delivery of location-based data and/or services may result in display of an agenda for the meeting with the employee, display of summaries of previous meetings between the executive and the employee, embedding of various links enabling communication with other employees who might be contacted to provide input into the meeting between the executive and the employee, forwarding of calls of the executive to the employee location (e.g., to the user device and/or to a phone of the employee), and the like, as well as various combinations thereof. In this embodiment, the identification of the customer locations'may be performed in any suitable manner, e.g., using GPS capabilities, using indoor location determination capabilities depicted and described herein, and the like, as well as various combinations thereof (which may depend on the size of the campus)

In such embodiments, the various location-based data and services depicted and described herein within the context of a healthcare environment may be adapted for providing similar location-based data and services in such other types of environments.

Furthermore, although primarily depicted and described herein within the context of specific types of environments in which the principles of the location-based healthcare capability may be used, it will be appreciated that the principles of the location-based healthcare capability may be adapted for use in any other suitable environment(s) in which various functions and capabilities of the location-based healthcare capability may be used for providing delivery of location-based data and/or services.

Accordingly, in many cases, various references herein to the location-based healthcare capability may be read more generally as being references to a location-based data and/or service delivery capability. Similarly, various references herein to healthcare environments and specific types of healthcare locations (e.g., hospital rooms, doctor offices, and the like) may be read more generally as being environments and locations which include indoor locations and/or outdoor locations. Similarly, various references herein to patients, and associated patient data and patient information, may be read more generally as being references to persons, and associated person data and person information since location-based delivery of data and/or services may be provided for various types of people in various other roles.

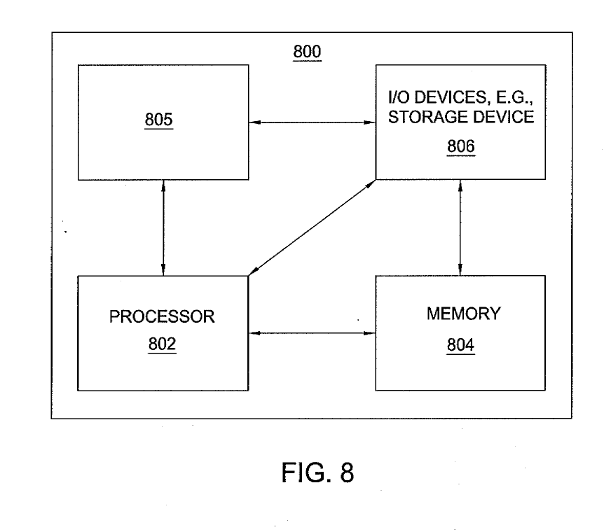

FIG. 8 depicts a high-level block diagram of a computer suitable for use in performing functions described herein.

As depicted in FIG. 8, computer 800 includes a processor element 802 (e.g., a central processing unit (CPU) and/or other suitable processor(s)), a memory 804 (e.g., random access memory (RAM), read only memory (ROM), and the like), a cooperating module/process 805, and various input/output devices 806 (e.g., a user input device (such as a keyboard, a keypad, a mouse, and the like), a user output device (such as a display, a speaker, and the like), an input port, an output port, a receiver, a transmitter, and storage devices (e.g., a tape drive, a floppy drive, a hard disk drive, a compact disk drive, and the like)).

It will be appreciated that the functions depicted and described herein may be implemented in software and/or in a combination of software and hardware, e.g., using a general purpose computer, one or more application specific integrated circuits (ASIC), and/or any other hardware equivalents. In one embodiment, the cooperating process 805 can be loaded into memory 804 and executed by processor 802 to implement the functions as discussed herein. Thus, cooperating process 805 (including associated data structures) can be stored on a computer readable storage medium, e.g., RAM memory, magnetic or optical drive or diskette, and the like.

It will be appreciated that computer 800 depicted in FIG. 8 provides a general architecture and functionality suitable for implementing functional elements described herein or portions of the functional elements described herein. For example, the computer 800 provides a general architecture and functionality suitable for implementing one or more of locator devices 111, tablets 120, LBSS 135, HDS 136, HSSs 137, systems 144, and the like.

It is contemplated that some of the steps discussed herein as software methods may be implemented within hardware, for example, as circuitry that cooperates with the processor to perform various method steps. Portions of the functions/elements described herein may be implemented as a computer program product wherein computer instructions, when processed by a computer, adapt the operation of the computer such that the methods and/or techniques described herein are invoked or otherwise provided. Instructions for invoking the inventive methods may be stored in fixed or removable media, transmitted via a data stream in a broadcast or other signal bearing medium, and/or stored within a memory within a computing device operating according to the instructions.

Although various embodiments which incorporate the teachings of the present invention have been shown and described in detail herein, those skilled in the art can readily devise many other varied embodiments that still incorporate these teachings.

What is claimed is:

1. A method, comprising:
determining a location of a user device;
determining a person associated with the determined location of the user device, and
initiating a process for propagating person data associated with the person toward the user device.

2. The method of claim 1, wherein the location is determined based on signal strength information received by a detector from at least one radiator.

3. The method of claim 1, wherein the person data comprises at least one of person information associated with the person and information configured for use in providing a location-based service associated with the person, wherein the person information comprises at least one of personal information of the person, emergency contact information of the person, medical history information of the person, and a test result of the person.

4. The method of claim 1, wherein at least a portion of the person data is propagated as a formatted page adapted for display via the user device, wherein the formatted page comprises at least one of:
a link associated with a medical record of the person;
a link associated with a test result of the person;
a click-to-call link associated with a telephone number of an emergency contact of the person or a healthcare professional associated with providing care for the person;
a click-to-conference link for initiating establishment of a conference between a plurality of healthcare professionals associated with providing care for the person; and
a push-to-talk link for enabling the user to initiate a conversation with at least one healthcare professionals associated with providing care for the person.

5. The method of claim 1, further comprising:
determining a role of a user of the user device;
wherein the person data comprises a subset of available person data that is available for the person, wherein the subset of person data is selected based on the role of the user of the user device.

6. The method of claim 1, further comprising:
receiving additional person data associated with the person;
determining a current location of the user device; and
automatically propagating the additional person data toward the user device when a determination is made that the current location of the user device is the location associated with the person.

7. The method of claim 1, further comprising:
propagating, toward the user device, information identifying at least one healthcare professional located near the location of the person.

8. The method of claim 1, further comprising:
receiving an indication of an incoming call intended for a user of the user device; and
when a determination is made that a current location of the user device is the location associated with the person and the incoming call is associated with the person, routing the incoming call to at least one of the user device, a phone located at or near the location of the user device, and a wireless phone of the user.

9. The method of claim 1, further comprising:
receiving an indication of an incoming call intended for a user of the user device; and
when a determination is made that a current location of the user device is the location associated with the person, propagating a transcription associated with the incoming call toward the user device.

10. The method of claim 1, further comprising:
automatically initiating a telephone call associated with the person, wherein the telephone call is automatically initiated between a device associated with a user of the user device and a device associated with another party.

11. An apparatus, comprising:
a processor configured for;
determining a location of a user device;
determining a person associated with the determined location of the user device, and
initiating a process for propagating person data associated with the person toward the user device.

12. An apparatus, comprising:
a processor configured for:
propagating, from user device toward a network element, information adapted for use by the network element in determining a location of the user device; and
receiving, at the user device, person data associated with a person determined to be associated with the location of the user device.

13. The apparatus of claim 12, wherein the information adapted for use by the network element in determining the location of the user device comprises at least one received signal strength indicator (RSSI) associated with at least one signal radiator, wherein the at least one RSSI is detected by the user device.

14. The apparatus of claim 12, wherein the processor is configured for determining the location of the user device by a location determination process comprising:
determining whether the user device was located within a room during a previous execution of the location determination process; and
when the user device was located within a room during the previous execution of the location determination process, determining whether the user device is still located within the room;
when the user device was not located within a room during the previous execution of the location determination process, determining whether the user device is currently located within a room.

15. The apparatus of claim 14, wherein determining whether the user device is still located within the room comprises:
polling a radiator associated with the room for its received signal strength indicator (RSSI);
determining whether the RSSI of the radiator associated with the room satisfies a threshold; and
when the RSSI of the radiator associated with the room satisfies the threshold, identifying the user device as still being located within the room;
when the RSSI of the radiator associated with the room does not satisfy the threshold, performing a discovery process for determining whether the user device is currently located within a room.

16. The apparatus of claim 14, wherein determining whether the user device is currently located within a room comprises:
discovering at least one radiator located within the vicinity of the user device;
for each located radiator, polling the radiator for its received signal strength indicator (RSSI);
determining, for each located radiator, whether its RSSI satisfies a threshold; and
when the RSSI of one of the located radiators satisfies the threshold, identifying the user device as being currently located within a room associated with the located radiator;
when no RSSI of any of the located radiators satisfies the threshold, determining that the user device is not currently located within a room.

17. The apparatus of claim 12, wherein the person data comprises at least one of person information associated with the person and information configured for use in providing a location-based service associated with the person, wherein the person information comprises at least one of personal information of the person, emergency contact information of the person, medical history information of the person, and a test result of the person.

18. The apparatus of claim 12, wherein at least a portion of the person data is received as a formatted page adapted for display via the user device, wherein the formatted page comprises at least one of:
a link associated with a medical record of the person;
a link associated with a test result of the person;
a click-to-call link associated with a telephone number of an emergency contact of the person or a healthcare professional associated with providing care for the person;
a click-to-conference link for initiating establishment of a conference between a plurality of healthcare professionals associated with providing care for the person; and
a push-to-talk link for enabling the user to initiate a conversation with at least one healthcare professionals associated with providing care for the person.

19. The apparatus of claim 12, wherein the processor is configured for:
propagating, toward the network element, an indication of a role of a user of the user device;
wherein the person data comprises a subset of available person data that is available for the person, wherein the subset of person data is selected based on the role of the user of the user device.

20. The apparatus of claim 12, wherein the processor is configured for:
receiving additional person data associated with the person; and
automatically initiating presentation of the additional person data associated with the person.

21. The apparatus of claim 12, wherein the processor is configured for:
receiving information identifying healthcare professionals located near the location of the patient.

22. The apparatus of claim 12, wherein the processor is configured for:
in response to detecting selection of a link associated with a medical record of the person or a test result of the person, initiating display of the medical record of the person or the test result of the person via a display interface of the user device, wherein the displayed medical record or test result has associated therewith an embedded link configured for enabling establishment of a communication session in response to selection of the embedded link.

23. The apparatus of claim 12, wherein the processor is configured for:
in response to detecting selection of a control mechanism associated with the person data, performing at least one of:
selecting a phone for the user of the user device based on the location of the user device; and
initiating signaling for requesting establishment of a communication session.

24. The apparatus of claim 12, wherein the processor is configured for:
automatically initiating a telephone call associated with the person, wherein the telephone call is automatically initiated between a device associated with a user of the user device and a device associated with another party.

25. A method, comprising:
propagating, from a user device toward a network element, information adapted for use by the network element in determining a location of the user device; and
receiving, at the user device, person data associated with a person determined to be associated with the location of the user device.
